(19) United States
(12) Patent Application Publication
(10) Pub. No.: US 2006/0148564 A1
(43) Pub. Date: Jul. 6, 2006

(54) Game control system

(75) Inventor: Scott Alan Herkelman, Chicago, IL (US)

Correspondence Address: AMIN LAW, LLC, 217 N. JEFFERSON ST., SUITE 100, CHICAGO, IL, 60661, US

(73) Assignee: BFG Technologies, Inc., Lake Forest, IL (US)

(21) Appl. No.: 11/326,056

(22) Filed: Jan. 5, 2006

Related U.S. Application Data
(60) Provisional application No. 60/642,181, filed on Jan. 6, 2005.

(51) Int. Cl. A63F 13/00

(52) U.S. Cl. 463/37

(57) ABSTRACT

The present invention provides a game control system including a keypad with programmable keys, a mouse with programmable keys, a laptop tray system, and at least one insertable, removable, and transferable memory profile card. The macro-programmable keypad and mouse features can record, save and use complex multiple key actions with the use of one key. The at least one memory profile card can record and save complex sequences of actions within a game for each individual game user.

### CROSS REFERENCE TO RELATED APPLICATIONS

This application claims the benefit of U.S. provisional application No. 60/642,181, filed on Jan. 6, 2005.

### FIELD OF THE INVENTION

The present invention relates to a game control system designed for use with console-based gaming systems. The game control system combines a mouse, keypad, laptop tray system, and at least one memory profile card. The game control system is designed to enhance the gaming experience by allowing macro-programmability functions for its components.

### BACKGROUND OF THE INVENTION

The present invention relates to a game control system designed for use with console-based gaming systems and has a mouse, keypad, laptop tray system and at least one memory profile card.

Many first person or strategy games are played solely on a personal computer (PC) due to the ease of use, accuracy and precision received from the mouse. A mouse provides a game user the ability to move around unrestricted with speed and accuracy and allows for real-time, unrestricted first-person point-of-view movement. Many other games are played solely on console-based gaming systems. However, these gaming system controllers must be hand-held and are frustrating and difficult to use with precision and accuracy.

Many PC-based and console-based gaming systems commonly require complex multiple key actions that require the game user to accurately and rapidly press multiple keys in sequence in order to produce the desired effect in the game. Many game users desire to save or record complex actions performed in order to avoid complicated and time consuming memorization and repetition of complex actions.

Gaming systems exist that are either PC-based or console-based. Currently, a gaming system does not exist in the gaming market combining the capabilities of both. A PC-based system offers a feature known in the industry as “free-look” which allows unrestricted first-person movement having additional speed and accuracy capabilities which a console-based system does not offer. The “free-look” feature of a PC-based system is performed with a mouse. Therefore, there is a need for a console-based game control system with a mouse to provide a game user the ability to move around unrestricted with speed and accuracy during play of first person or strategy games.

Console-based gaming systems currently use a hand-held game controller with a keypad and additional controls. The hand-held game controller is not supported and often more difficult to use than a standard keyboard and mouse system that a PC-based system uses. A need exists for a console-based game control system when used with a keypad and mouse combination that provides a gaming system controller that is supported on the user's lap through use of a laptop tray system or other similar means.

Gaming systems currently exist in which the user must utilize multiple keys for a sequence of actions. The use of multiple keys is complicated and time-consuming. Therefore, there is a need within a game control system for keys having the ability for programming with complex multiple key actions such that a game user only presses one key in order to produce the same effect as when multiple keys are pressed.

Memory cards exist on both PC-based and console-based gaming systems to allow the user to save game progress. No such memory card exists that allows the user to save an individual profile. An individual profile includes programming by the user of one or more keys such that one key represents a sequence of multiple key actions. Saving the individual profile is an efficient method to allow the user to save their settings for different games without having to re-program their individual settings with each use. By saving the individual profile, this allows users of different abilities the opportunity to compete on the same level. There is therefore a need for a game control system with an insertable, removable, and transferable memory profile card to allow the storage of complex multiple key actions and other sequences of events to be recorded and saved.

Summarily, there is a need for a console-based game control system combining a mouse with programmable keys, a keypad with programmable keys, and an insertable, removable, and transferable memory profile card supported by a laptop tray system that has the intended benefits and features of the present invention.

### SUMMARY OF THE INVENTION

The present invention has a keypad with programmable keys, a mouse with programmable keys, a laptop tray system, and at least one insertable, removable, and transferable memory profile card. The macro-programmable keypad and mouse features provide accuracy, precision, stability, and ease of use when playing games on a console-based gaming system and are used primarily to enhance the console-based gaming experience by offering stability, efficiency, precision, quickness, and flexibility.

The macro-programmable keypad and mouse features provide the ability to record and use complex multiple key sequence actions with the use of one key. The macro-programmable keypad and mouse also provide at least one memory profile card for recording and saving complex sequence of actions within a game and allows the macro-programmable features of the keypad and mouse to be saved per individual game users.

### BRIEF DESCRIPTION OF DRAWINGS

FIG. 1 is a perspective view of the game control system with the mouse, keypad and laptop tray system

FIG. 2 is a top view of the game control system with the mouse, keypad and laptop tray system.

FIG. 3 is a front view of the laptop tray system with keypad.

FIG. 4 is a back view of the laptop tray system with keypad.

FIG. 5 is a bottom view of the laptop tray system.

FIG. 6 is a right side view of the keypad with the laptop tray system.

FIG. 7 is a left side view of the keypad with the laptop tray system.

FIG. 8 is a top view of the laptop tray system.

FIG. 9 is a bottom side view of the keypad.

FIG. 10 is a top side view of the keypad.

### DETAILED DESCRIPTION OF THE INVENTION

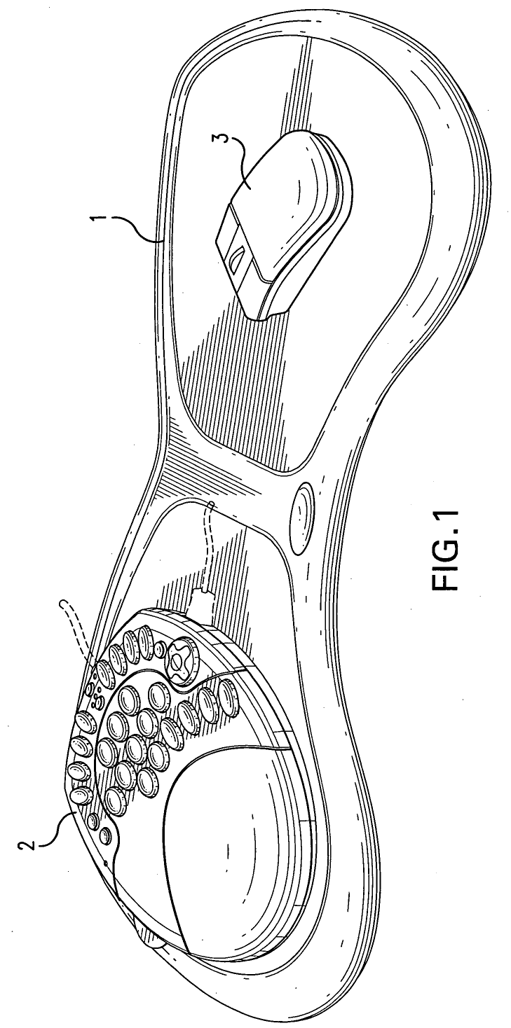

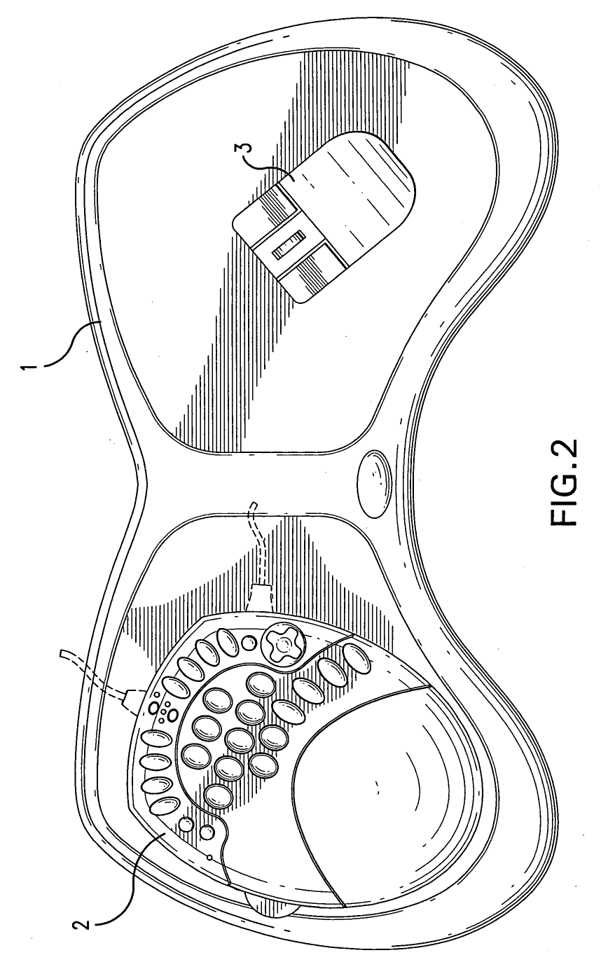

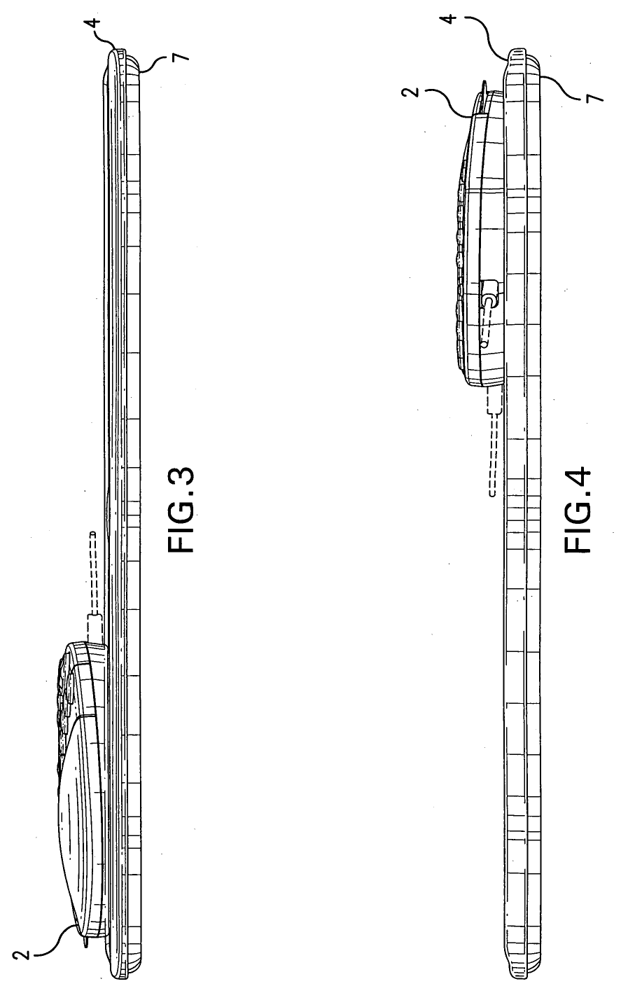

The present invention relates to a macro-programmable keypad and mouse supported by a laptop tray system and memory capabilities by use of at least one memory profile card for use with console-based gaming systems. FIG. 1 and FIG. 2 illustrate the present invention with a laptop tray system 1, a keypad 2, a mouse 3, and at least one memory profile card.

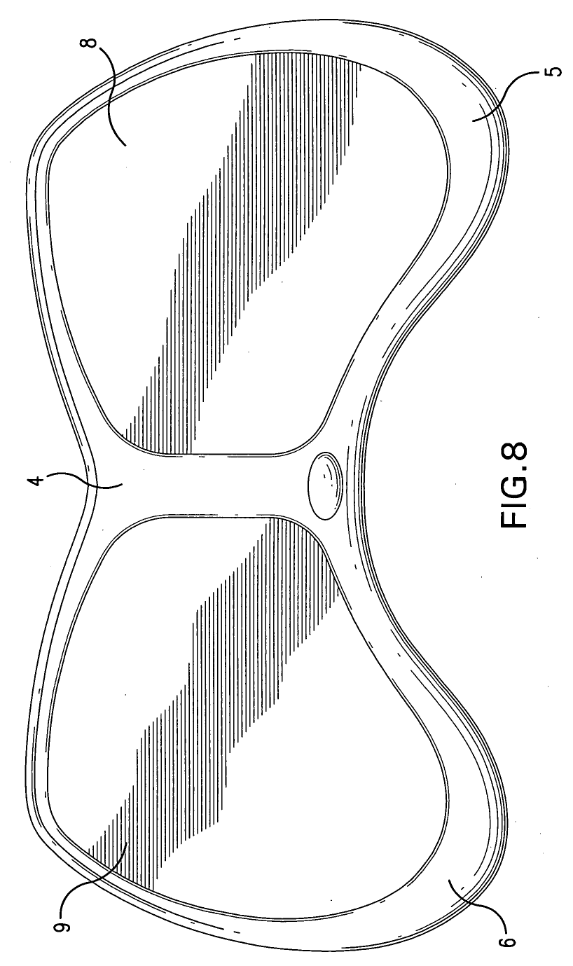

FIG. 8 illustrates the top view of the laptop tray system 1. The laptop tray system 1 has a base top 4, a base bottom 7, a base right 5 and a base left 6.

In one preferred embodiment, the laptop tray system 1 is a molded, unitary structure composed of plastic or similarly rigid material. In another embodiment, base right 5 and base left 6 may be connected by a releasable joint. Suitably, a snapping or other similar means releasably connects base right 5 and base left 6 to form laptop tray system 1. The snapping or other similar means allows the user to easily store the laptop tray system 1 when not in use. The connection of base right 5 and base left 6 is ideally supported by two bars (not shown) for added strength and rigidity. The at least one memory profile card is preferably inserted on the base left 6 side.

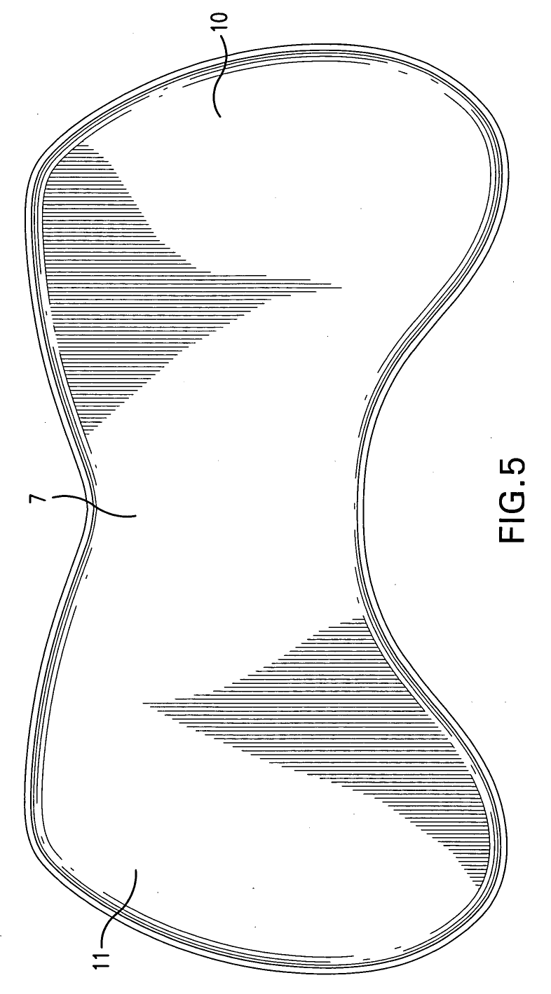

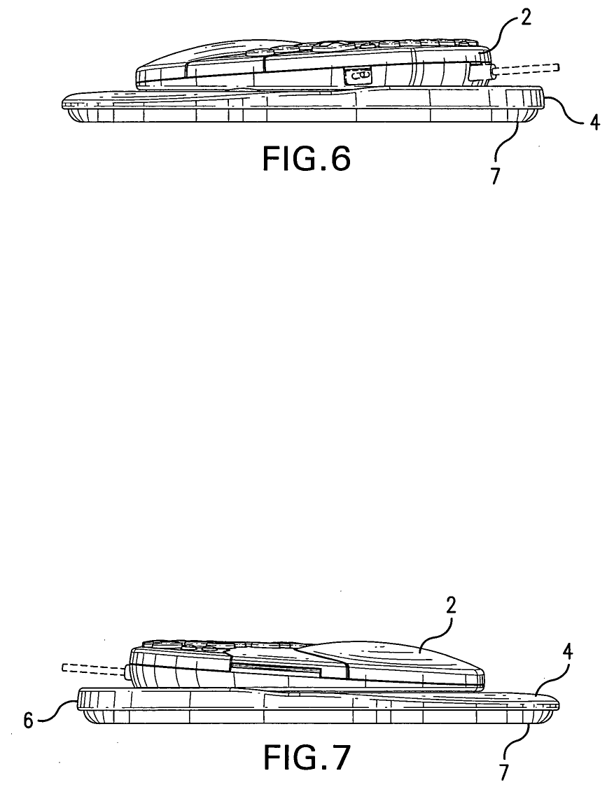

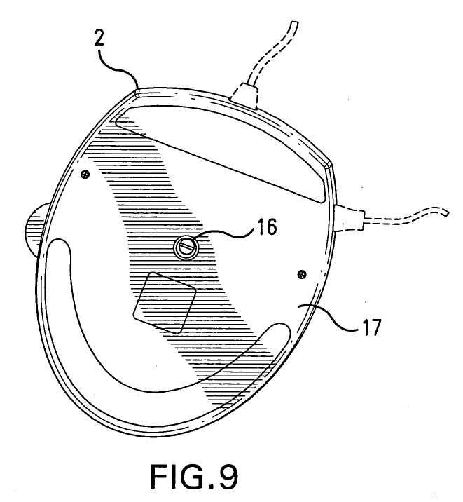

The base top 4 is further comprised of base pad right 8 and base pad left 9 as shown in FIG. 8. The base pad right 8 and the base pad left 9 house the mouse 3 and the keypad 2. The base top 4 is further comprised of a female portion for receiving the keypad 2 by a screw mechanism 16 as illustrated in FIG. 9. In one preferred embodiment, the mouse 3 is housed on base pad right 8 and the keypad 2 is housed on base pad left 9. The base bottom 7 is further comprised of support right 10 and support left 11 as shown in FIG. 5. In one preferred embodiment, the support right 10 and support left 11 are composed of soft rubber or similar material. In a further preferred embodiment, the laptop tray system 1 supports the keypad 2 and mouse 3 on the console-based game control system user's lap for stability and ease of use during gaming.

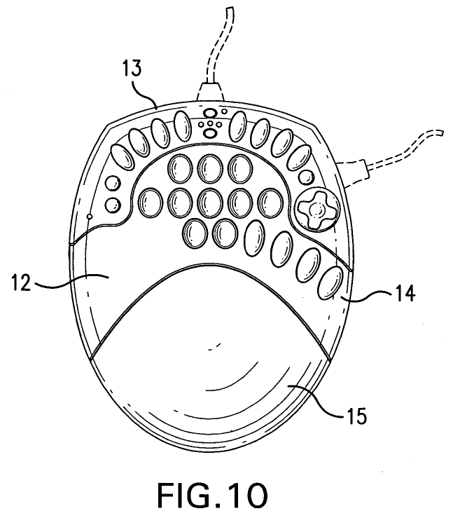

The keypad 2 has game control top 12 as shown in FIG. 10 and a game control bottom 17 as shown in FIG. 9. In one preferred embodiment, the keypad 2 is composed of plastic or other similarly rigid material. The game control top 12 is further comprised of one or more keypad memory related keys 13, one or more gaming related keys 14, and a palm rest 15 as shown in FIG. 10. As illustrated in FIG. 10, the one or more keypad memory related keys 13 record and save a sequence of multiple key actions into one key for use during gaming. In one preferred embodiment, there are at least eight keys in the one or more keypad memory related keys 13. The keypad 2 allows for standard and known actions used in commercially available games programmed into its memory. The possible key sequences capable of being recorded onto the one or more keypad memory related keys 13 include the standard and known actions used in commercially available games and programmed into the game control system internal memory. In one preferred embodiment, a user records and saves a sequence of multiple key actions onto the one or more keypad memory related keys 13 by pressing a record button, followed by the multiple key sequence desired to be saved and finally the desired keypad memory related key 13. The user of the game control system preferably presses the desired keypad memory related key 13 when wanting to use a saved multiple key sequence during gaming. The one or more gaming related keys 14 includes keys for moving up and down, accessing saved profiles, starting games, selecting actions, indicating an individual profile is in use, and recording key sequences and other profile data. In one preferred embodiment, the one or more gaming related keys 14 includes standard arrow keys found on a QWERTY keyboard. In a further preferred embodiment, the standard arrow keys can be swapped with the functions of a standard gaming directional pad which allows the user of the game control system to move in eight directions to provide further accuracy. In another preferred embodiment, the one or more gaming related keys 14 includes LED lights in different colors to indicate different functions, such as indicating an individual profile is in use. In one preferred embodiment, the one or more gaming related keys 14 are specifically for use with the PLAYSTATION 2 gaming system manufactured and sold by Sony Computer Entertainment America, Inc. In another preferred embodiment, the one or more gaming related keys 14 are specifically for use with the XBOX gaming system manufactured and sold by Microsoft. The palm rest 15 is used to stabilize the user's hand while using the keypad 2. In one preferred embodiment, the palm rest 15 is composed of rubber plastic or similar material. The keypad 2 will further have a cord and means for connecting to a console-based gaming system.

The mouse 3 is comprised of a scroll wheel and standard left and right mouse buttons. The mouse provides a game user the ability to move around unrestricted with speed and accuracy during play of first person or strategy games on a console-based gaming system. The mouse 3 contains one or more mouse memory related keys within the scroll wheel and standard left and right mouse buttons to record and save multiple key sequences into one key for use during gaming. In one preferred embodiment, there are at least five keys in the one or more mouse memory related keys. The mouse 3 has the ability for the standard and known actions used in commercially available games to be programmed into its memory. The possible sequences to be recorded and saved onto the one or more mouse memory related keys include the standard and known actions used in commercially available games and programmed into the game control system internal memory. In one preferred embodiment, a user records and saves a sequence of multiple key actions onto the one or more mouse memory related keys by pressing a record button, followed by the multiple key sequence desired to be saved and finally the desired mouse memory related key. The user of the game control system preferably presses the desired mouse memory related key when wanting to use a saved multiple key sequence during gaming. In a further preferred embodiment, the mouse 3 has a cord for connection means to the keypad 2.

The at least one memory profile card is used for recording, saving, and transferring information. The at least one memory profile card has the capability for saving individual profiles. An individual profile includes programming by the game control system user of one or more keys such that one key represents a sequence of multiple key actions. In one preferred embodiment the at least one memory profile card saves at least three individual profiles. In one preferred embodiment, the individual profiles includes programming recorded and saved onto the one or more keypad memory related keys 13 and the one or more mouse memory related keys for saving a sequence of multiple key actions into one key. Further preferred, the at least three individual profiles record and save at least thirteen multiple key sequences into one key which includes at least eight keypad memory related keys 13 and at least five mouse memory related keys, for a total of at least thirty-nine multiple key sequences into one key. The user of the game control system can preferably switch between individual profiles during gaming. In one preferred embodiment, the one or more gaming related keys 14 includes a profile key for the user of the game control system to switch between individual profiles during gaming. The individual profiles saved on one memory profile card can preferably be transferred and saved onto another memory profile card. The user of the game control system can preferably clear the saved individual profiles. Further the internal memory of the game control system can preferably be saved onto one memory profile card. The memory saved onto one memory profile card can preferably be saved onto the game control system internal memory. The at least one memory profile card preferably inserts into a female slot within the base left side 6 of the keypad 2.

In one preferred embodiment, the keypad 2, the mouse 3, and the at least one memory profile card interact and are compatible with the PLAYSTATION 2 console-based gaming system manufactured and sold by Sony Computer Entertainment American, Inc. In another preferred embodiment, the keypad 2, the mouse 3, and the at least one memory profile card interact and are compatible with the XBOX console-based gaming system manufactured and sold by Microsoft.

While in the foregoing specification this invention has been described in relation to certain preferred embodiments thereof, and many details have been set forth for the purpose of illustration, it will be apparent to those skilled in the art that the invention is susceptible to additional embodiments and that certain details described herein can be varied considerably without departing from the basic principles of the invention.

We claim:

1. A game control system for use with a console-based gaming system, the game control system comprising:
a laptop tray system;
a mouse moveably positioned on a surface of the laptop tray system;
a keypad positioned with respect to the laptop tray system; and
at least one memory profile card positioned with respect to the laptop tray system.

2. The game control system of claim 1 wherein the laptop tray system comprises a base top, a base bottom, a base right, and a base left.

3. The game control system of claim 2 wherein the laptop tray system comprises a releasable joint connecting the base right to the base left.

4. The game control system of claim 2 wherein the base right and the base left further comprise a base pad right and a base pad left for housing the mouse and the keypad.

5. The game control system of claim 1 wherein the laptop tray system is a molded, unitary structure.

6. The game control system of claim 1 or 2 wherein the keypad comprises a game control top and a game control bottom.

7. The game control system of claim 6 wherein the base top comprises a female portion for receiving a screw mechanism on the game control bottom.

8. The game control system of claim 6 wherein the game control top comprises one or more keypad memory related keys, one or more gaming related keys, and a palm rest.

9. The game control system of claim 8 wherein the one or more keypad memory related keys record and save multiple key sequences onto one key.

10. The game control system of claim 8 wherein the one or more gaming related keys are cooperative with one or more commercially available console-based gaming systems.

11. The game control system of claim 1 wherein the mouse comprises a scroll wheel and left and right buttons.

12. The game control system of claim 11 wherein the scroll wheel and left and right buttons comprise one or more mouse memory related keys.

13. The game control system of claim 12 wherein the one or more mouse memory related keys record and save multiple key sequences onto one mouse key.

14. The game control system of claim 1 wherein the at least one memory profile card records and saves individual profiles.

15. The game control system of claim 14 wherein the individual profiles comprise multiple key sequences recorded and saved onto one or more keys such that one key represents a sequence of multiple key actions.

16. The game control system of claim 14 wherein the individual profiles comprise multiple key sequences recorded and saved onto the one or more mouse memory related keys and the one or more keypad memory related keys.

17. The game control system of claim 14 wherein the individual profiles transfer and save onto another memory profile card.

18. The game control system of claim 1 wherein the keypad comprises a female slot for receiving the at least one memory profile card.

19. The game control system of claim 1, wherein the keypad, mouse and at least one memory profile card are cooperative with one or more commercially available console-based gaming systems.
